(19) United States
(12) Patent Application Publication
(10) Pub. No.: US 2007/0189246 A1
(43) Pub. Date: Aug. 16, 2007

(54) Buffering multimedia mobile devices and methods to operate the same

(76) Inventor: Lajos Molnar, Rowlett, TX (US)

Correspondence Address: TEXAS INSTRUMENTS INCORPORATED, P O BOX 655474, M/S 3999, DALLAS, TX, 75265, US

(21) Appl. No.: 11/352,844

(22) Filed: Feb. 13, 2006

(51) Int. Cl. H04Q 7/24

(52) U.S. Cl. 370/338

(57) ABSTRACT

Buffering multimedia mobile devices and methods to operate the same are disclosed. A disclosed example mobile device comprises a user interface to initiate a call, an audio codec to receive an audio signal, a memory to store a first portion of the audio signal received before the call is established, and a transceiver to, after the call is established, send a second portion of the received audio signal and the first stored portion of the received audio signal, wherein the second portion of the audio signal is substantially sent in real-time, and wherein a combination of the first and the second portions of the audio signal substantially represent the audio signal.

### FIELD OF THE DISCLOSURE

This disclosure relates generally to mobile devices and, more particularly, to buffering multimedia mobile devices and methods to operate the same.

### BACKGROUND

Currently, calls placed to emergency services (e.g., 911 calls) are limited to a real-time exchange of audio signals once an emergency call is established between a caller and an emergency response center. Example audio signals include sounds made and/or words spoken by the caller. Presently, there is no capability and/or provision for capturing biometric, audio and/or video signals before the call is established and/or if the call is interrupted.

### BRIEF DESCRIPTION OF THE DRAWINGS

FIG. 1 is a schematic illustration of an example emergency response system employing a buffering multimedia mobile device.

FIG. 2 illustrates an example manner of implementing the example buffering multimedia mobile device of FIG. 1

FIG. 3 illustrates an example manner of implementing the example emergency response system and/or the example multimedia receiver of FIG. 1.

FIG. 4 is a flowchart representative of an example process that may be carried out to implement the example buffering multimedia mobile device of FIG. 1.

FIG. 5 is a flowchart representative of an example process that may be carried out to implement the example emergency response center and/or the example multimedia receiver of FIG. 1.

FIG. 6 is a schematic illustration of an example processor platform that may be used and/or programmed to execute the example processes of FIGS. 4 and/or 5.

### DETAILED DESCRIPTION

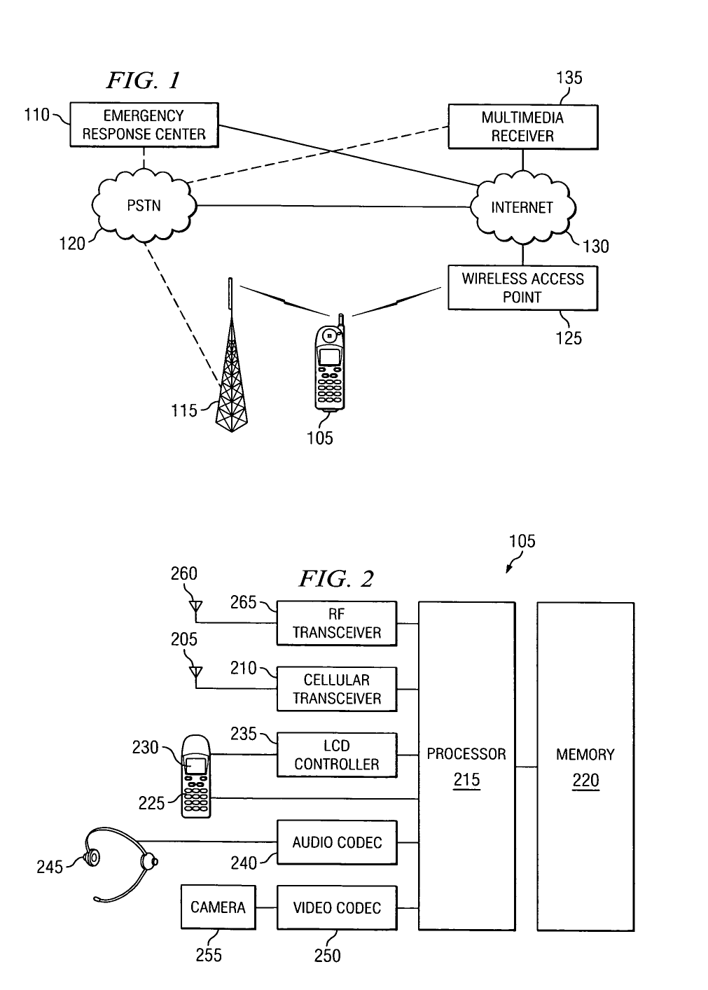

FIG. 1 is a schematic illustration of an example emergency response system employing a buffering multimedia mobile device 105. An example buffering multimedia mobile device 105 is discussed below in connection with FIG. 2. In the example emergency response system of FIG. 1, the example buffering multimedia mobile device 105 is configured to communicate with an emergency response center 110 via any variety of communication devices and/or communication networks. For example, as illustrated in FIG. 1, the example buffering multimedia mobile device 105 may be communicatively coupled to the example emergency response center 110 via any variety of cellular communication networks 115 and a public switched telephone network (PSTN) 120, and/or via any variety of wireless access points 125 and the Internet 130. While the following disclosure is made with reference to the example communication networks, services and/or devices illustrated in FIG. 1, persons of ordinary skill in the art will readily appreciate that other combinations and/or varieties of communication networks, services and/or devices may be used to communicatively couple the example buffering multimedia mobile device 105 and the example emergency response system 110.

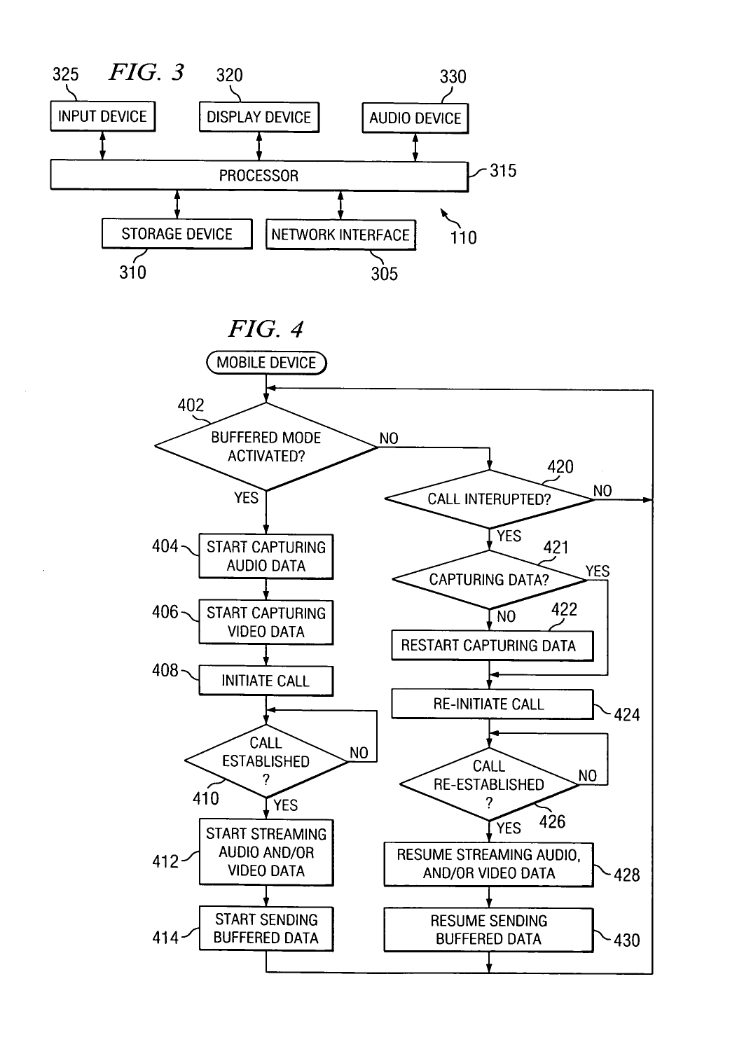

As illustrated in FIG. 1, the example buffering multimedia mobile device 105 may also be communicatively coupled to a multimedia receiver 135 that is capable to process and/or output buffering multimedia content received from the example buffering multimedia mobile device 105. Example multimedia receivers 135 include personal computers, a personal digital assistants (PDA), etc. An example manner of implementing the example emergency response center 110 and/or the example multimedia receiver 135 is discussed below in connection with FIG. 3.

In the illustrated example of FIG. 1, a user (not shown) of the example buffering multimedia mobile device 105 initiates a buffering multimedia emergency call and/or communication session to the emergency response center 110 via any variety of methods. For example, the user may press a panic button, may press and hold down any combination of keys and/or buttons, use a keypad to dial 911, etc. to initiate a buffering multimedia emergency call. The user may similarly initiate a buffering multimedia call and/or communication session with the multimedia receiver 135 by, for example, pressing a start button, pressing and holding any combination of keys and/or buttons, dialing a phone number, etc.

When the user initiates a buffering multimedia call and/or communication session (emergency or non-emergency), the example buffering multimedia mobile device 105 of FIG. 1 starts (or continues) capturing and storing audio, biometric and/or video data to a storage device (e.g., a memory device) implemented by the buffering multimedia mobile device 105. The example buffering multimedia mobile device 105 also starts establishing a communication session and/or communication link to the called party (e.g., the emergency response center 110, the multimedia receiver 135, etc.). While the communication session is being established, the example buffering multimedia mobile device 105 of FIG. 1 continues capturing and storing audio, biometric and/or video data. In the example of FIG. 1, the buffering multimedia mobile device 105 starts capturing and storing the audio, biometric and/or video before establishing the communication session. Of course, they may be performed at essentially the same time and/or they could be performed in the reverse order.

In the illustrated example of FIG. 1, once the communication session is established, the example buffering multimedia mobile device 105 starts streaming, in real-time, live audio, biometric and/or video data to the called party. The audio, biometric and/or video data being streamed represents audio, biometric and/or video data currently being received by the example buffering multimedia mobile device 105 of FIG. 1. Additionally, the example buffering multimedia mobile device 105 may continue capturing and storing the streamed real-time audio, biometric and/or video data. In the example of FIG. 1, the audio, biometric and/or video data captured and stored prior to and/or during establishment of the communication session represents a first portion of the audio, biometric and/or video data, and the streamed real-time data represents a second portion of the audio, biometric and/or video data. It will be readily apparent to persons of ordinary skill in the art that the first and the second portions of the audio, biometric and/or video data may be combined to form a complete representation of the audio, biometric and/or video data received by the example buffering multimedia mobile device 105 of FIG. 1.

In the example of FIG. 1, the called party, by receiving, processing, outputting and/or displaying the streamed audio, biometric and/or video data, can listen to and/or view what is currently happening at and/or nearby the buffering multimedia mobile device 105. For example, an operator of the emergency response center 110 can both listen to information spoken by the user of the buffering multimedia mobile device 105 concerning an emergency event as well as view video of the emergency scene. For instance, a buffering multimedia mobile device 105 operated by a person viewing an automobile accident can capture video footage and/or photos of the accident enabling the emergency response center operator to better ascertain what emergency personnel and/or equipment should be dispatched. In another example, streamed audio, biometric and/or video data provides information regarding a perpetrator of a crime such as, for example, a burglar, an attacker, etc.

In a medical emergency, streamed audio, biometric and/or video data may provide information regarding the health status of a caller or a person to whom the caller is attending and/or allow a medical professional to view and/or assess the medical condition of the caller or a person to whom the caller is attending. Additionally, if any variety of biometric input devices (e.g., a heart rate monitor) are implemented by and/or coupled to the buffering multimedia mobile device 105, the example buffering multimedia mobile device 105 of FIG. 1 could capture and store and/or stream live biometric information and/or data to the emergency response center 110 and/or a medical response center, a medical office and/or a hospital having, for example, a multimedia receiver 135.

In yet another example, the user of the example buffering multimedia mobile device 105 of FIG. 1, realizing that an event-of-interest is occurring, initiates a buffering multimedia session to the multimedia receiver 135. In the example of FIG. 1, the example buffering multimedia mobile device 105 starts capturing and storing audio, biometric and/or video data while the buffering multimedia mobile device 105 attempts to establish the communication session. Once the session is established, the buffering multimedia mobile device 105 starts streaming live real-time audio, biometric and/or video data so that an operator of the multimedia receiver 135 can start viewing, live and in real-time, the event-of-interest. An example event-of-interest is a mother watching her child take their first steps and desiring to send audio, biometric and/or video data of the event to the father who is currently at work.

Simultaneous and/or subsequent to the streaming of the live real-time audio, biometric and/or video data, the example buffering multimedia mobile device 105 of FIG. 1 sends the captured and stored audio, biometric and/or video data to the called party. The captured and/or stored audio, biometric and/or video data can be sent using any excess communication bandwidth between the buffering multimedia mobile device 105 and the called party. If no excess communication bandwidth is available, and/or a communication session is not established, the example buffering multimedia mobile device 105 retains the captured and stored audio, biometric and/or video data for transfer at a later time and/or date. For example, police may use audio and/or video data stored on a recovered stolen buffering multimedia mobile device 105 to help solve a crime.

At the emergency response center 110 and/or the multimedia receiver 135, the streamed live real-time audio, biometric and/or video data (i.e., second portion of the audio, biometric and/or video data) can be combined with the captured and stored audio, biometric and/or video data (i.e., first portion of the audio, biometric and/or video data) to create a complete record of an event. For example, the emergency response center 110 can re-create and/or review the complete record of an emergency event captured by the example buffering multimedia mobile device 105 and is, thus, not limited to just the second portion of the audio, biometric and/or video information streamed after the call was established. Likewise, the multimedia receiver 135 can rewind to the beginning of the captured and stored audio, biometric and/or video data to view the entire event of interest, including the first portion of the audio, biometric and/or video data that was captured and stored and, thus, not originally viewed.

In the example emergency response system of FIG. 1, the example buffering multimedia mobile device 105 using any of a variety of methods and/or techniques packetizes the audio, biometric and/or video data before sending the audio, biometric and/or video data to the emergency response center 110 or the multimedia receiver 135 (i.e., the called party). Further, the audio, biometric and/or video data packets include one or more pieces of information that enable the emergency response center 110 or the multimedia receiver 135 to combine the captured and stored first portion of the audio, biometric and/or video data with the streamed second portion of the audio, biometric and/or video data. For instance, the packets could be numbered to allow the emergency response center 110 or the multimedia receiver 135 to assemble the received data packets in the correct sequence and/or order.

In the illustrated example of FIG. 1, the communication session established between the buffering multimedia mobile device 105 and the called party may be interrupted for any of a variety of reasons. For example, a cellular communication session may be terminated due to signal fading, interference, signal loss, etc; a device failure and/or service interruption within one or more communication devices and/or networks communicatively coupling the buffering multimedia mobile device 105 and the called party; an attacker might disconnect the session (e.g., hang up the phone); etc.

The example buffering multimedia mobile device 105 of FIG. 1, after a communication session interruption, automatically continues capturing and storing a third portion of the audio, biometric and/or video data if the buffering multimedia mobile device 105. If the example buffering multimedia mobile device 105 was not capturing and storing audio, biometric and/or video data prior to the interruption, the example buffering multimedia mobile device 105 automatically re-starts capturing and storing a third portion of the audio, biometric and/or video data if the buffering multimedia mobile device 105. The example buffering multimedia mobile device 105 then attempts to re-establish the communication session. If the communication session is re-established the buffering multimedia mobile device 105 resumes streaming live real-time audio, biometric and/or video data (i.e., a fourth portion of the audio, biometric and/or video data). Simultaneously and/or subsequently, using any excess communication bandwidth, the example buffering multimedia mobile device 105 of FIG. 1, sends the additionally captured and stored third portion of the audio, biometric and/or video data. In this fashion, the example buffering multimedia mobile device 105 of FIG. 1 attempts to continuously capture, record and/or communicate as much emergency and/or event-of-interest audio, biometric and/or video data as possible.

In the example of FIG. 1, the example buffering multimedia mobile device 105 continues capturing and storing audio, biometric and/or video data, and/or continues establishing and/or re-establishing communication sessions and streaming live real-time audio, biometric and/or video data until, for example, a user of the example buffering multimedia mobile device 105 purposely disables the buffering multimedia communication session. Additionally or alternatively, emergency center personnel and/or a called party may signal and/or otherwise effect the end of the buffering multimedia communication session. For example, the buffering multimedia communication session may be disabled by pressing and holding a panic button, entering via a keypad a personal identification number (PIN), etc. In an example in which an attacker steals a buffering multimedia mobile device 105, the example buffering multimedia mobile device 105 of FIG. 1 may continue to capture, store and/or provide information to the emergency response center 110 about the attacker, the attacker's location and/or the attack.

FIG. 2 illustrates an example manner of implementing at least a portion of the example buffering multimedia mobile device 105 of FIG. 1. To support wireless communications with a cellular communication network, the example buffering multimedia mobile device 105 of FIG. 2 includes any of a variety of cellular antenna 205 and any of a variety of cellular transceiver 210. The example cellular antenna 205 and the example cellular transceiver 210 of FIG. 2 are able to receive, demodulate and decode cellular signals transmitted to the example buffering multimedia mobile device 105 by, for instance, the example cellular communication network 115 (FIG. 1). Likewise, the cellular transceiver 210 and the cellular antenna 205 are able to encode, modulate and transmit cellular signals from the example buffering multimedia mobile device 105 to the cellular communication network 115.

To process received and decoded signals and to provide data for transmission, the illustrated example buffering multimedia mobile device 105 of FIG. 2 includes a processor 215. The processor 215 may be any of a variety of processors such as, for example, a microprocessor, a microcontroller, a digital signal processor (DSP), an advanced reduced instruction set computing (RISC) machine (ARM) processor, etc. In general, the processor 215 executes machine readable instructions stored in any variety of memories 220 to control the example buffering multimedia mobile device 105 of FIG. 2 and/or to provide one or more of a variety of user interfaces, applications, services, functionalities implemented and/or provided by the example buffering multimedia mobile device 105 of FIG. 2. For example, the example processor 215 of FIG. 2 implements the example process illustrated in FIG. 4.

The example memory 220 of FIG. 2 is also used to store captured audio, biometric and/or video data. The example memory 200 may include read only memory (ROM) and/or random access memory (RAM). RAM may be implemented by dynamic random access memory (DRAM), Synchronous DRAM (SDRAM) and/or any other type of RAM device, and ROM may be implemented by any desired type of memory device. Access to the example memory 220 is typically controlled by a memory controller (not shown) in a conventional manner.

In addition to handling receive and/or transmit data, the example processor 215 of FIG. 2 may receive user inputs and/or selections, and/or provide any variety and/or number user interfaces for a user of the example buffering multimedia mobile device 105. For example, the processor 215 may receive inputs and/or selections made by a user via a keyboard 225, and/or provide a user interface on a display 230 (e.g., a liquid crystal display (LCD) 230) via, for instance, an LCD controller 235. They keypad 225 may include any variety and/or number of keys and/or buttons. An example keypad 225 includes numbered keys for dialing a telephone number, a panic button to initiate and end an emergency buffering multimedia call to the emergency response center 110, etc. Other example input devices include a touch screen, a mouse, etc. Input devices may also include any variety of input devices to capture biometric data such as, for example, blood sugar, heart rate, etc. The example display 230 of FIG. 2 may be used to display any of a variety of information such as, for example, a web browser, an application, menus, caller identification information, a picture, video, a list of telephone numbers, a list of video and/or audio channels, phone settings, etc.

To provide, for example, telephone services, the example buffering multimedia mobile device 105 of FIG. 2 includes any of a variety of audio coder-decoder (codec) 240 and any variety of input and/or output devices such as, for instance, a jack for a headset 245. In particular, the example processor 215 of FIG. 2 can receive a digitized and/or compressed voice signal from the headset 245 via the audio codec 240, and then transmit the digitized and/or compressed voice signal via the cellular transceiver 210 and the antenna 205 to the cellular communication network 115. Likewise, the example processor 215 can receive a digitized and/or compressed voice signal from the cellular communication network 115 and output a corresponding analog signal via, for example, the headset 245 for listening by a user.

To provide, for example, video services, the example buffering multimedia mobile device 105 of FIG. 2 includes any of a variety of video codecs 250 and any of a variety of video input devices such as, for instance, a camera 255. In particular, the processor 215 can receive a digitized and/or compressed video signal from the camera 255 via the video codec 250, and then transmit the digitized and/or compressed video signal via the cellular transceiver 210 and the antenna 205 to the cellular communication network 115. In the illustrated example of FIG. 2, the example camera 255 and the example video codec 250 can receive and provide to the example processor 215 a continuous video signal and/or a sequence of one or more snapshots.

To support additional or alternative communication services, the example buffering multimedia mobile device 105 of FIG. 2 may include any variety of RF antennas 260 and/or RF transceivers 265. An example RF antenna 260 and the example RF transceiver 265 support wireless communications based on the IEEE 802.11(a.k.a., wireless fidelity (WiFi)) standard. Additionally or alternatively, an RF transceiver 265 may support communications based on one or more alternative communication standards and/or protocols. Alternatively, the cellular antenna 205 may be used by the RF transceiver 265. Further, a single transceiver may be used to implement both the cellular transceiver 210 and the RF transceiver 265.

In the illustrated example of FIG. 2, the processor 215 may use the RF transceiver 265 to communicate with, among other devices, the wireless access point 125 (FIG. 1), etc. For instance, the example RF transceiver 265 of FIG. 2 may be used to enable the example buffering multimedia mobile device 105 to connect to the Internet 130.

Although an example buffering multimedia mobile device 105 has been illustrated in FIG. 2, mobile devices may be implemented using any of a variety of other and/or additional devices, components, circuits, modules, etc. Further, the devices, components, circuits, modules, elements, etc. illustrated in FIG. 2 may be combined, re-arranged, eliminated and/or implemented in any of a variety of ways. For example, the buffering multimedia mobile device 105 may be a wireless-enabled laptop where the antenna 205, the antenna 260, the cellular transceiver 210 and/or the RF transceiver 265 are implemented on any variety of PC card. For simplicity and ease of understanding, the following discussion references the example buffering multimedia mobile device 105 of FIG. 2, but any mobile device could be used.

FIG. 3 illustrates an example manner of implementing at least a portion of the example emergency response center 110 and/or the example multimedia receiver 135 of FIG. 1. To receive packetized audio, biometric and/or video data from a buffering multimedia mobile device 105, the example emergency response center 110 of FIG. 3 includes any variety of network interfaces 305. To store received packetized audio, biometric and/or video data, the example emergency response center 110 of FIG. 3 includes any variety of storage devices 310. Example storage devices 310 include a hard disk drive, a memory device, a compact disc, etc.

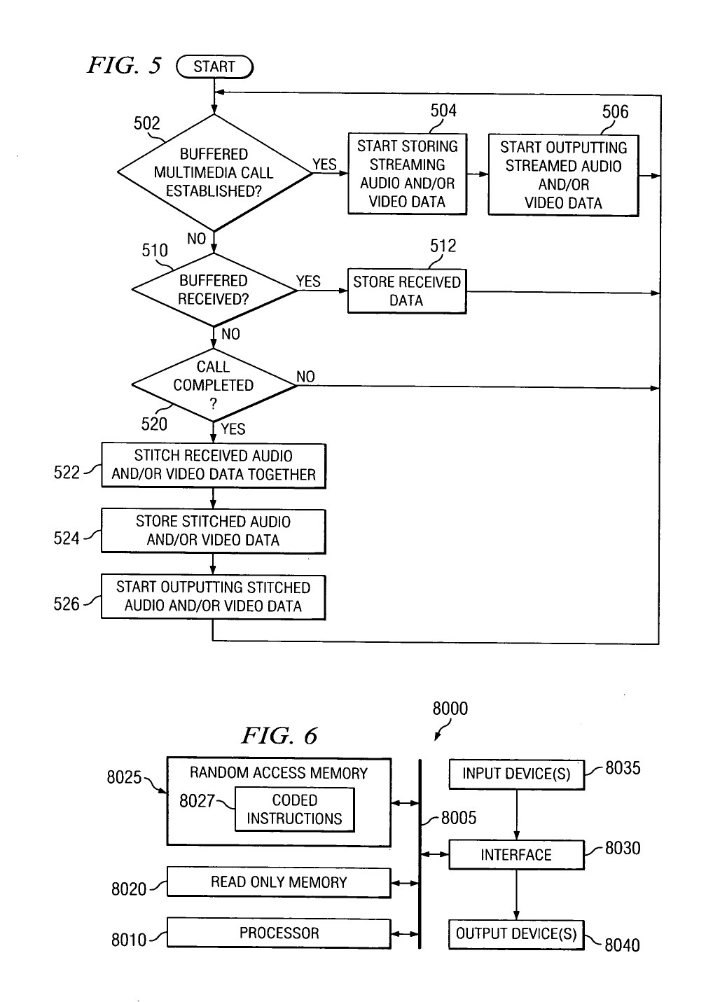

To control and/or operate the emergency response center 110, the example emergency response center 110 includes any of a variety of processor 315. The example processor 315 of FIG. 3 executes coded instructions present in a main memory of the processor 315. For example, the coded instructions may be present in the storage device 310 and may be executed to, for instance, carry out any portion of the example process illustrated in FIG. 5. The processor 315 may be any type of processing unit, such as, for example, a microprocessor from the Intel®, AMD®, IBM®, or SUN® families of microprocessors.

To allow an operator of the emergency response center 110 to interact with the emergency response center 110, the example emergency response center 110 of FIG. 3 includes any variety of display devices 320, input devices 325 and audio devices 330. In the illustrated example of FIG. 3, the example display device 320 is used to display information about an ongoing communication session (e.g., the telephone number of a caller, the location of a caller, biometric data and/or information, etc.), video data received from the caller, etc. Example input devices 325 are a keyboard, a mouse, etc. configured to allow an emergency response center operator to interact with and/or provide inputs to the example emergency response center 110.

An example audio device 330 includes an audio codec and a jack that allow a headset (not shown) to be communicatively coupled to the example emergency response center 110 of FIG. 3. The headset and the example audio device 330 of FIG. 3 allow an emergency response center operator to talk with a user of the example buffering multimedia mobile device 105 and/or to listen to streamed live real-time audio data and/or audio data captured, stored and provided to the example emergency response center 110 by the buffering multimedia mobile device 105.

FIGS. 4 and 5 illustrate flowcharts representative of example processes that may be carried out to implement the example buffering multimedia mobile device 105, the example emergency response center 110 and/or the multimedia receiver 135. For example, the example processes of FIGS. 4 and/or 5 may be embodied in coded instructions stored on a tangible medium such as a flash memory, or RAM associated with a processor, a controller and/or any other suitable processing device (e.g., the example processor 215 of FIG. 2, the example processor 315 of FIG. 3 and/or the processor 8010 shown in the example processor platform 8000 and discussed below in conjunction with FIG. 6). The embodied coded instructions may be executed to implement the example buffering multimedia mobile device 105, the example emergency response center 110 and/or the multimedia receiver 135. Alternatively, some or all of the example processes of FIGS. 4 and/or 5 may be implemented using an application specific integrated circuit (ASIC), a programmable logic device (PLD), a field programmable logic device (FPLD), discrete logic, hardware, firmware, etc. Also, some or all of the example processes of FIGS. 4 and/or 5 may be implemented manually or as combinations of any of the foregoing techniques, for example, a combination of firmware, software and/or hardware. Further, although the example processes of FIGS. 4 and 5 are described with reference to the flowcharts of FIGS. 4 and 5, persons of ordinary skill in the art will readily appreciate that many other methods of implementing the example buffering multimedia mobile device 105, the example emergency response center 110 and/or the multimedia receiver 135 may be employed. For example, the order of execution of the blocks may be changed, and/or some of the blocks described may be changed, eliminated, sub-divided, or combined. Additionally, persons of ordinary skill in the art will appreciate that the example machine readable instructions of FIGS. 4 and/or 5 be carried out sequentially and/or carried out in parallel by, for example, separate processing threads, processors, devices, circuits, etc.

The example process of FIG. 4 begins with the example buffering multimedia mobile device 105 determining if a user is initiating a buffering communication session by, for example, pressing a start button, pressing and holding any combination of keys and/or buttons, dialing a phone number, etc. (block 402). If the user is initiating a buffering communication session (block 402), the buffering multimedia mobile device 105 starts capturing via, for example, the audio codec 240 and storing audio data in, for example, the memory 220 (block 404). If the buffering multimedia mobile device 105 has a camera 255 and video codec 250, the buffering multimedia mobile device 105 starts capturing and storing video data in, for example, the memory 220 (block 406). Additionally and/or alternatively, the buffering multimedia mobile device 105 may start capturing and storing biometric data in the memory 220. Next, the buffering multimedia mobile device 105 initiates via, for example, the cellular transceiver 210, a buffering multimedia communication session to, for example, the emergency response center 110 or the multimedia receiver 135 (block 408). The buffering multimedia communication session may be initiated using any variety of techniques, methods and/or protocols. For example, a call initiation packet can include data and/or information indicating that the session being initiated is a buffering session. Additionally and/or alternatively a new type of call initiation protocol and/or data packet may be implemented to initiate buffered multimedia sessions.

The buffering multimedia mobile device 105 then waits for the communication session to be established (block 410). When the call is established (block 410), the buffering multimedia mobile device 105 starts streaming live real-time audio, biometric and/or video data to, for example, the emergency response center 110 or the multimedia receiver 135 (block 412). The streaming live real-time audio, biometric and/or video data may be sent using any of a variety of protocols, communication methods and/or data packets. The buffering multimedia mobile device 105 also starts sending the captured and stored audio, biometric and/or video data (block 414). The captured and/or stored audio, biometric and/or video data may be sent in, for example, data packets that distinguish them from the streaming audio, biometric and/or video data. The data packets may be created in accordance with any variety of data transmission protocol. The example process of FIG. 4 then returns to block 402.

If the call is not established (block 410), the buffering multimedia mobile device 105 continues waiting. Alternatively, the buffering multimedia mobile device 105 starts a countdown timer, and when the timer expires, control returns to block 408 to attempt to initiate the call again.

Returning to block 402, if a user is not initiating a buffering communication session, the buffering multimedia mobile device 105 determines if an ongoing buffering multimedia session was interrupted (block 420). If an ongoing call was not interrupted (block 420), control returns to block 402. If an ongoing call was interrupted (block 420) and if the buffering multimedia mobile device 105 is not currently capturing and storing audio, biometric and/or video data (block 421), the buffering multimedia mobile device 105 re-starts capturing and storing audio, biometric and/or video data (block 422). Control then proceeds to block 424. If an ongoing call was interrupted (block 420) and if the buffering multimedia mobile device 105 is currently capturing and storing audio, biometric and/or video data (block 421), the buffering multimedia mobile device 105 continues capturing and storing audio, biometric and/or video data and control proceeds to block 424.

At block 424, the buffering multimedia mobile device 105 re-initiates the buffering multimedia communication session. The buffering multimedia mobile device 105 then waits for the communication session to be re-established (block 426). When the call is re-established (block 426), the buffering multimedia mobile device 105 resumes streaming live real-time audio, biometric and/or video data (block 428). The buffering multimedia mobile device 105 also resumes sending the original and/or the additional captured and stored audio, biometric and/or video data (block 430). In the example process of FIG. 4, the called party is informed that the session was interrupted and is being resumed and, thus, the called party can correctly sequence and/or correlate audio, video and/or biometric data from the previous session with the current session. The example process of FIG. 4 then returns to block 402.

The example process of FIG. 5 begins with the example emergency response center 110 or the multimedia receiver 135 determining if a buffering multimedia session has been established (block 502). If a buffering multimedia session has been established (block 502), the emergency response center 110 starts storing the received streamed real-time audio, biometric and/or video data in, for example, the storage device 310 (block 504) and starts displaying and/or outputting the real-time audio, biometric and/or video data via, for example, the display device 320 and/or the audio device 330 (block 506). The example process of FIG. 5 then returns to block 502.

Returning to block 502, if a buffering multimedia session was not established, the emergency response center 110 determines if captured and stored (i.e., buffering) audio, biometric and/or video data was received (block 510). If buffering audio, biometric and/or video data was received (block 510), the emergency response center 110 stores the received audio, biometric and/or video data in, for example, the storage device 310 (block 512). The example process of FIG. 5 then returns to block 502.

Returning to block 510, if buffering audio, biometric and/or video data was not received, the emergency response center 110 determines if a buffering communication session was ended (block 520). If a buffering communication session was ended (block 520), the emergency response center 110 combines (i.e., stitches together) any streamed real-time audio, biometric and/or video data and any buffering audio, biometric and/or video data received from the buffering multimedia mobile device (block 522). For instance, the emergency response center 110 combines, orders and/or stitches together the data packets representing the first, second, third, etc. portions of the received audio, biometric and/or video data. The emergency response center 110 stores the stitched audio, biometric and/or video data in, for example, the storage device 310 (block 524). The emergency response center 110 then starts displaying and/or outputting the stitched audio, biometric and/or video data via, for example, the display device 320 and/or the audio device 330 (block 526). Additionally and/or alternatively, the stitching together of the streamed and the buffered data may be performed while the streamed data is being received. Thus, for example, the emergency response center 110 can view the entire emergency event from the beginning while the event is still ongoing. For example, a first emergency operator can watch what is currently occurring, while a second operator watches from the beginning. Additionally or alternatively, a display at the emergency response center 110 can display multiple segments of the emergency event simultaneously. The example process of FIG. 5 then returns to block 502.

FIG. 6 is a schematic diagram of an example processor platform 8000 that may be used and/or programmed to implement the example buffering multimedia mobile device 105, the example emergency response center 110 and/or the multimedia receiver 135. For example, the processor platform 8000 can be implemented by one or more general purpose microprocessors, microcontrollers, etc.

The processor platform 8000 of the example of FIG. 6 includes a general purpose programmable processor 8010. The processor 8010 executes coded instructions 8027 present in main memory of the processor 8010 (e.g., within a RAM 8025). The processor 8010 may be any type of processing unit, such as a microprocessor from the Intel®, AMD®, IBM®, or SUN® families of microprocessors. The processor 8010 may implement, among other things, the example processes illustrated in FIGS. 4 and/or 5 to implement the example buffering multimedia mobile device 105, the example emergency response center 110 and/or the multimedia receiver 135.

The processor 8010 is in communication with the main memory (including a ROM 8020 and the RAM 8025) via a bus 8005. The RAM 8025 may be implemented by DRAM, SDRAM, and/or any other type of RAM device, and ROM may be implemented by flash memory and/or any other desired type of memory device. Access to the memory 8020 and 8025 is typically controlled by a memory controller (not shown) in a conventional manner.

The processor platform 8000 also includes a conventional interface circuit 8030. The interface circuit 8030 may be implemented by any type of well-known interface standard, such as an external memory interface, serial port, general purpose input/output, etc.

One or more input devices 8035 and one or more output devices 8040 are connected to the interface circuit 8030. The input devices 8035 and output devices 8040 may be used, for example, to implement interfaces between the example buffering multimedia mobile device 105 and the cellular communication network 115 and/or the wireless access point 125; between the emergency response center 110 and/or the multimedia receiver 135 and the PSTN 120 and/or the Internet 130; etc.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A mobile device comprising:
a user interface to initiate a call;
an audio codec to receive an audio signal;
a memory to store a first portion of the audio signal received before the call is established; and
a transceiver to, after the call is established, send a second portion of the received audio signal and the first stored portion of the received audio signal, wherein the second portion of the audio signal is substantially sent in real-time, and wherein a combination of the first and the second portions of the audio signal substantially represent the audio signal.

2. A mobile device as defined in claim 1, wherein the audio codec starts receiving the audio signal and the memory starts storing the first portion of the audio signal when the call is initiated.

3. A mobile device as defined in claim 1, wherein the user interface to initiate the call comprises at least one of a panic button, a buffering call button, or a keypad to dial a telephone number.

4. A mobile device as defined in claim 1, wherein the transceiver is at least one of a cellular transceiver or a radio frequency transceiver.

5. A mobile device as defined in claim 1, wherein the first and the second portions of the audio signal are packetized, and wherein data packets containing the first and the second portions of the audio signal contain at least one of a timestamp or a sequence number to facilitate combining of the first and the second portions of the audio signals.

6. A mobile device as defined in claim 1, wherein the memory is configured to store a third portion of the audio signal if the call is disconnected, wherein the third portion of the audio signal is received by the audio codec after the call is disconnected.

7. A mobile device as defined in claim 6, wherein the transceiver is configured to send to, after the call is re-established, send a fourth portion of the received audio signal and the third stored portion of the received audio signal, wherein the fourth portion of the audio signal is sent in substantially real-time, and wherein the first, the second, the third and the fourth portions of the audio signal may be combined to represent the audio signal.

8. A mobile device as defined in claim 1, further comprising a video codec to receive a video signal, wherein the memory is configured to store a first portion of the received video signal before the call is established, and wherein the transceiver is configured to, after the call is established, send a second portion of the received video signal and the first stored portion of the received video signal, wherein the second portion of the video signal is sent in real-time, and wherein the first and the second portions of the video signal may be combined to represent the video signal.

9. A mobile device as defined in claim 8, wherein the video signal is a sequence of snapshots.

10. A mobile device as defined in claim 1, further comprising a biometric input device to receive biometric data, wherein the memory is configured to store a first portion of the received biometric data before the call is established, and wherein the transceiver is configured to, after the call is established, send a second portion of the received biometric data and the first stored portion of the received biometric data, wherein the second portion of the biometric data is sent in real-time, and wherein the first and the second portions of the biometric data may be combined to represent the biometric data.

11. For a mobile device, a method comprising:
establishing a communications link;
receiving an audio signal present at the mobile device;
capturing a first portion of the audio signal to a storage device, wherein the first portion of the audio signal is a portion of the audio signal occurring before the communications link is established;
streaming a second portion of the audio signal across the communications link, wherein the second portion of the audio signal is a portion of the audio signal following the first portion of the audio signal; and
sending the first stored portion of the audio signal across the communications link.

12. A method as defined in claim 11, wherein capturing the first portion of the audio signal commences when establishing the communication link is started.

13. A method as defined in claim 11, wherein streaming the second portion of the audio signal commences when the communication link is established.

14. A method as defined in claim 11, wherein sending the first stored portion of the audio signal does not interfere with streaming the second portion.

15. A method as defined in claim 11, further comprising:
capturing a first portion of at least one of a video signal or a biometric signal to the storage device, wherein the first portion of the at least one of the video signal or the biometric signal is a portion of the at least one of the video signal or the biometric signal occurring before the communications link is established;
streaming a second portion of the at least one of the video signal or the biometric signal across the communications link, wherein the second portion of the at least one of the video signal or the biometric signal is a portion of the at least one of the video signal or the biometric signal following the first portion of the video signal; and
sending the first stored portion of the at least one of the video signal or the biometric signal across the communications link.

16. An emergency response center comprising:
a network interface to receive a first portion and a second portion of an audio signal from a mobile device, wherein the first portion of the audio signal is a portion of the audio signal occurring before a communications link to the mobile device is established, wherein the second portion of the audio signal is a portion of the audio signal following the first portion of the audio signal, and wherein the second portion of the audio signal is received in substantially real-time; and
a storage device to store the first and the second portions of the audio signal.

17. An emergency response center as defined in claim 16, further comprising a processor to combine the first and the second portions to re-create the audio signal.

18. An emergency response center as defined in claim 17, further comprising an audio device to output the re-created audio signal.

19. An emergency response center as defined in claim 16, further comprising an audio device to output the second portion of the audio signal as the second portion of the audio signal is received.

20. An emergency response center as defined in claim 16, wherein the network interface is configured to receive a first portion and a second portion of a video signal from the mobile device, wherein the first portion of the video signal is a portion of the video signal occurring before the communications link to the mobile device is established, wherein the second portion of the video signal is a portion of the video signal following the first portion of the video signal, and wherein the second portion of the video signal is received in real-time, and wherein the storage device is configured to store the first and the second portions of the video signal.

21. An emergency response center as defined in claim 20, wherein the video signal is a sequence of photographs.

22. An emergency response center as defined in claim 16, wherein the network interface is configured to receive a first portion and a second portion of a biometric signal from the mobile device, wherein the first portion of the biometric signal is a portion of the biometric signal occurring before the communications link to the mobile device is established, wherein the second portion of the biometric signal is a portion of the biometric signal following the first portion of the biometric signal, and wherein the second portion of the biometric signal is received in real-time, and wherein the storage device is configured to store the first and the second portions of the biometric signal.

23. A method comprising:
receiving a first portion of an audio signal from a mobile device, wherein the first portion of the audio signal is a portion of the audio signal occurring before a communications link to the mobile device is established; and
receiving a second portion of the audio signal from the mobile device, wherein the second portion of the audio signal is a portion of the audio signal occurring after the communications link is established.

24. A method as defined in claim 23, further comprising combining the first and the second portions of the audio signal to re-create the audio signal.

25. A method as defined in claim 23, further comprising outputting the second portion of the audio signal while the second portion of the audio signal is being received.

26. A method as defined in claim 23, further comprising:
receiving a first portion of at least one of a video signal or a biometric signal from the mobile device, wherein the first portion of the at least one of the video signal or the biometric signal is a portion of the at least one of the video signal or the biometric signal occurring before the communications link to the mobile device is established; and
receiving a second portion of the at least one of the video signal or the audio signal from the mobile device, wherein the second portion of the at least one of the video signal or the biometric signal is a portion of the at least one of the video signal or the biometric signal occurring after the communications link is established.

27. An article of manufacture storing machine readable instructions which, when executed, cause a machine to:
establish a communications link;
receive an audio signal present at the mobile device;
capture a first portion of the audio signal to a storage device, wherein the first portion of the audio signal is a portion of the audio signal occurring before the communications link is established;
stream a second portion of the audio signal across the communications link, wherein the second portion of the audio signal is a portion of the audio signal following the first portion of the audio signal; and
send the first stored portion of the audio signal across the communications link.

28. An article of manufacture as defined in claim 27, wherein the machine readable instructions, when executed, cause the machine to start capturing the first portion of the audio signal when starting to establish the communication link.

29. An article of manufacture as defined in claim 27, wherein the machine readable instructions, when executed, cause the machine to stream the second portion of the audio signal when the communication link is established.

30. An article of manufacture as defined in claim 27, wherein the machine readable instructions, when executed, cause the machine to:
capture a first portion of at least one of a video signal or a biometric signal to the storage device, wherein the first portion of the at least one of the video signal or the biometric signal is a portion of the at least one of the video signal or the biometric signal occurring before the communications link is established;
stream a second portion of the at least one of the video signal or the biometric signal across the communications link, wherein the second portion of the at least one of the video signal or the biometric signal is a portion of the at least one of the video signal or the biometric signal following the first portion of the at least one of the video signal or the biometric signal; and
send the first stored portion of the at least one of the video signal or the biometric signal across the communications link.
